(19) United States
(12) Patent Application Publication
(10) Pub. No.: US 2026/0277900 A1
(43) Pub. Date: Sep. 17, 2026

(54) DATA QUERY METHOD, DATA QUERY APPARATUS, AND COMPUTER-PROGRAM PRODUCT

(71) Applicant: BOE Technology Group Co., Ltd., Beijing (CN)

(72) Inventor: Ang Li, Beijing (CN)

(73) Assignee: BOE Technology Group Co., Ltd., Beijing (CN)

(21) Appl. No.: 19/680,194

(22) Filed: May 18, 2026

Related U.S. Application Data
(63) Continuation-in-part of application No. 18/004,886, filed on Dec. 20, 2021, now Pat. No. 12,675,476.

(51) Int. Cl. G06F 16/2453; G06F 16/248

(52) U.S. Cl. CPC G06F 16/24542; G06F 16/248

(57) ABSTRACT

A data query method is provided. The data query method includes receiving query description; processing, by a processor, the query description using one or more components; determining query statement; and querying a data source based on the query statement to obtain query result. Processing the query description using the one or more components includes creating a query logic relation stack based on the query description; generating a plurality of processing nodes in the query logic relation stack according to a plurality of processing types indicated by the query description; and performing logic relation calculation on the query logic relation stack to generate final logic relation data; wherein determining the query statement comprises converting the final logic relation data into the query statement.

### CROSS-REFERENCE TO RELATED APPLICATION

This application is a continuation-in-part of U.S. application Ser. No. 18/004,886, filed Dec. 20, 2021, which a national stage application under 35 U.S.C. § 371 of International Application No. PCT/CN2021/139567, filed Dec. 20, 2021. Each of the forgoing applications is herein incorporated by reference in its entirety for all purposes.

### TECHNICAL FIELD

The present invention relates to display technology, more particularly, to a data query method, a data query apparatus, and a computer-program product.

### BACKGROUND

Traditional data query methods require developing software tailored for specific customer needs, each of which would require an extended period of development time. These traditional data query methods also lack flexibility in allowing the user to define rules. In addition, some traditional data query methods require storing data locally, making the data query process rather bulky.

### SUMMARY

In one aspect, the present disclosure provides a data query method, comprising receiving query description; processing, by a processor, the query description using one or more components; determining query statement; and querying a data source based on the query statement to obtain query result; wherein processing the query description using the one or more components comprises creating a query logic relation stack based on the query description; generating a plurality of processing nodes in the query logic relation stack according to a plurality of processing types indicated by the query description; and performing logic relation calculation on the query logic relation stack to generate final logic relation data; wherein determining the query statement comprises converting the final logic relation data into the query statement.

Optionally, the query description indicates a plurality of operations; each of the plurality of operations corresponds to a respective processing type of the plurality of processing types; and each of the plurality of processing nodes corresponds to a respective operation of the plurality of operations.

Optionally, the respective operation corresponds to processing logic configured to process a query clause of the query description or query processing information indicated by the query description.

Optionally, the plurality of processing types include at least one of a query type, a field setting type, a filter type, an order type, a grouping type, an aggregation type, a formula type, a vertical table association type, a horizontal association type, a conditional column type, a field adding type, a field renaming type, or a field hiding type.

Optionally, the data query method further comprises selecting a dataset; rendering a page display based on first metadata of the dataset; adding an operation through the page display; updating operation data of the operation to the first metadata to generate second metadata; and submitting the second metadata to a back end for query construction; wherein at least part of the query description is generated based on the second metadata.

Optionally, the data query method, prior to selecting the dataset, further comprises adding the data source; loading the data source; selecting a data table to be used from the data source; reading a table structure of the data table; constructing table metadata based on the table structure; and saving the table metadata; wherein the table metadata includes information describing the data table and is associated with the dataset.

Optionally, the second metadata includes an operation list including a plurality of operations arranged according to an operation sequence.

Optionally, generating the plurality of processing nodes comprises selecting a current operation from the operation list according to the operation sequence; and generating a current processing node in the query logic relation stack corresponding to the current operation.

Optionally, the data query method further comprises determining a processing type of the current processing node; selecting a parser corresponding to the processing type; and parsing, using the parser, a portion of the query description corresponding to the current processing node to generate a parsed query description.

Optionally, the parser is selected from a plurality of parsers, and wherein the plurality of parsers include at least one of a field filtering parser, a formula column adding parser, a field setting parser, a field sorting parser, a grouping and aggregation parser, a vertical table association parser, a horizontal table association parser, or a conditional column adding parser.

Optionally, the data query method further comprises generating, for the current processing node, a current relation node or a current expression node based on the parsed query description.

Optionally, performing the logic relation calculation comprises updating, by a relation builder, the query logic relation stack based on the current relation node or the current expression node.

Optionally, upon a determination that the operation list includes an unprocessed operation, the data query method returns to selecting another operation from the operation list as the current operation.

Optionally, upon a determination that the operation list does not include an unprocessed operation, the relation builder generates a final relation node based on the query logic relation stack after the query logic relation stack is updated by the relation builder, and the final logic relation data includes the final relation node.

Optionally, the final relation node represents a query plan corresponding to the plurality of operations in the operation list.

Optionally, the relation builder is implemented by a RelBuilder tool of an Apache Calcite library, the current relation node or the final relation node is implemented by a RelNode of the Apache Calcite library, and the current expression node is implemented by a RexNode of the Apache Calcite library.

Optionally, the data query method further comprises reading, by the back end, the second metadata; loading the data source corresponding to the dataset indicated by the second metadata; determining a data source type based on the second metadata; selecting a metadata processing component corresponding to the data source type; and executing, by the metadata processing component, operation processing on the second metadata to generate an intermediate query representation; wherein the final logic relation data includes the intermediate query representation; wherein the method further comprises converting the intermediate query representation into the query statement; and executing the query statement through a data source connector to obtain the query result.

Optionally, the logic relation calculation determines at least one of an execution order, a dependency relation, a nesting relation, or a target data object for at least one of the plurality of processing nodes; and wherein, when the plurality of processing nodes include a join processing node and a filter processing node or an order processing node subsequent to the join processing node, a target data object of the filter processing node or the order processing node is determined as a joined result generated by the join processing node rather than an original data table.

In another aspect, the present disclosure provides a data query apparatus, comprising a memory; one or more processors; wherein the memory and the one or more processors are connected with each other; and the memory stores computer-executable instructions for controlling the one or more processors to receive query description; process the query description using one or more components; determine query statement; and query a data source based on the query statement to obtain query result; wherein the one or more processors are configured to create a query logic relation stack based on the query description; generate a plurality of processing nodes in the query logic relation stack according to a plurality of processing types indicated by the query description; perform logic relation calculation on the query logic relation stack to generate final logic relation data; and convert the final logic relation data into the query statement.

In another aspect, the present disclosure provides a computer-program product comprising a non-transitory tangible computer-readable medium having computer-readable instructions thereon, the computer-readable instructions being executable by a processor to cause the processor to perform receiving query description; processing the query description using one or more components; determining query statement; and querying a data source based on the query statement to obtain query result; wherein processing the query description using the one or more components comprises creating a query logic relation stack based on the query description; generating a plurality of processing nodes in the query logic relation stack according to a plurality of processing types indicated by the query description; and performing logic relation calculation on the query logic relation stack to generate final logic relation data; wherein determining the query statement comprises converting the final logic relation data into the query statement.

### BRIEF DESCRIPTION OF THE FIGURES

The following drawings are merely examples for illustrative purposes according to various disclosed embodiments and are not intended to limit the scope of the present invention.

FIG. 1 is a flow chart illustrating a data query method in some embodiments according to the present disclosure.

FIG. 2A is a flow chart illustrating a data query method in some embodiments according to the present disclosure.

FIG. 2B is a flow chart illustrating a data query method in some embodiments according to the present disclosure.

FIG. 3 is a flow chart illustrating a data query method in some embodiments according to the present disclosure.

FIG. 4 is a flow chart illustrating a data query method in some embodiments according to the present disclosure.

FIG. 5 is a schematic diagram illustrating a data query apparatus in some embodiments according to the present disclosure.

FIG. 6 is a flow chart illustrating a data query method in some embodiments according to the present disclosure.

FIG. 7 is a flow chart illustrating a data query method in some embodiments according to the present disclosure.

FIG. 8 is a flow chart illustrating a dataset creation process in some embodiments according to the present disclosure.

FIG. 9 is a flow chart illustrating a front end query configuration process in some embodiments according to the present disclosure.

FIG. 10 is a flow chart illustrating a back end query construction and execution process in some embodiments according to the present disclosure.

FIG. 11 is a flow chart illustrating an operation processing process in some embodiments according to the present disclosure.

### DETAILED DESCRIPTION

The disclosure will now be described more specifically with reference to the following embodiments. It is to be noted that the following descriptions of some embodiments are presented herein for purpose of illustration and description only. It is not intended to be exhaustive or to be limited to the precise form disclosed.

The present disclosure provides, inter alia, a data query method, a data query apparatus, and a computer-program product that substantially obviate one or more of the problems due to limitations and disadvantages of the related art. In one aspect, the present disclosure provides a data query method. In some embodiments, the data query method includes receiving query description; processing, by a processor, the query description using one or more components; and determining query statement. Optionally, processing the query description includes obtaining query field from the query description; processing the query field using the one or more components; and determining a first sub-statement. The present data query method allows a user to self-define query rules, and supports a variety of data sources of different formats, enabling cross-data source data query and analysis.

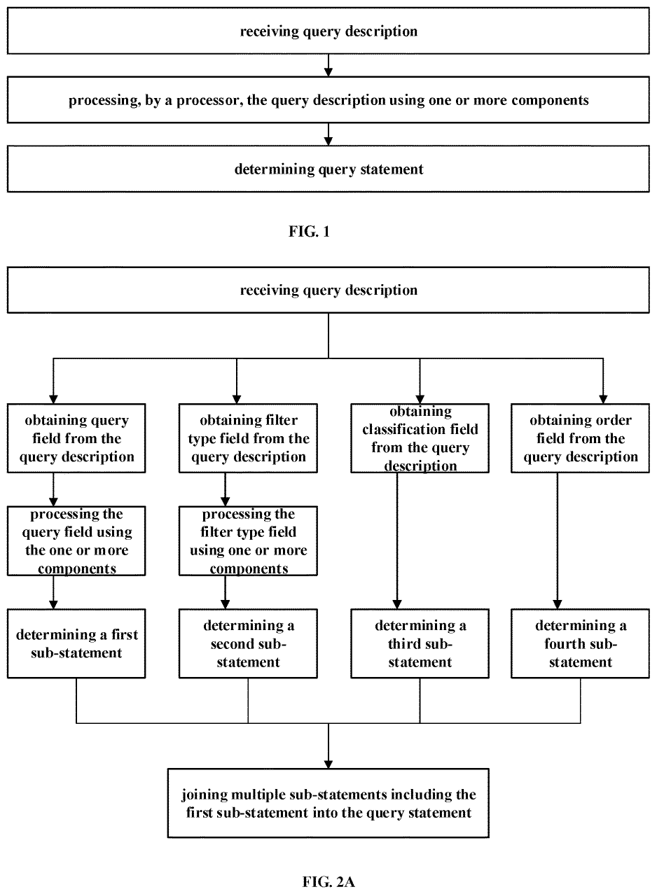

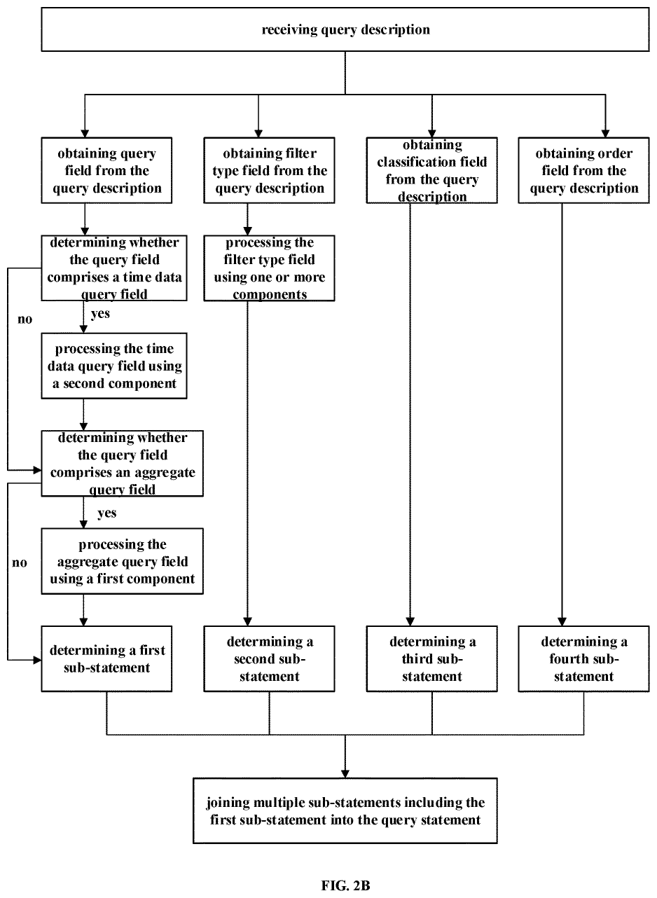

FIG. 1 is a flow chart illustrating a data query method in some embodiments according to the present disclosure. FIG. 2A is a flow chart illustrating a data query method in some embodiments according to the present disclosure. Referring to FIG. 1 and FIG. 2A, the data query method in some embodiments includes receiving query description; processing, by a processor, the query description using one or more components; and determining query statement. In some embodiments, the query description may be submitted by a user at a front-end application, e.g., through a user interface. In one example, dynamic query conditions such as the query description received at the front-end are interpreted into corresponding query information, based on different data source types, to generate the query statement. The query statement is then transmitted to a query engine for executing the data query.

In some embodiments, the query description includes one or more fields for interpretation by the one or more components. Examples of fields of the query description includes query field, filter type field, classification field, and order field. In one example, the data query method is performing a query and analysis on vehicles. An example of query field may be “vehicle models”. An example of filter type field may be “compact size”. The filter type field is used for filtering the data. An example of classification field may be “passenger car” or “carriage truck”. An example of order field may be “ASC”, which denotes an ascending order.

As used herein, the term “component” refers to a computer-related entity, for example, a process running on a processor. In the present data query method, the one or more component includes at least one user-defined component. The term “user-defined” refers to that one or more aspects may be specified by a user, for example, prior to the runtime or at runtime. The one or more aspect that may be user-defined include, for example, time data type, time data format, aggregation function parameter, aggregation function name, character type field filter, numeric type field filter, and date data type field filter.

The present method enables data query and analysis across multiple data sources. Different data sources may have different data description formats, whereas the query engine uses a query statement (for example, SQL statement) that may be compatible with data description format of one data source but incompatible with data description format of another. To decouple data description from query statement of the query engine, the present method introduce at least one user-defined component that are configured to process data descriptions from different data sources into a uniform query statement, thereby enabling dynamic generation of query statement.

Various appropriate user-defined components may be implemented in the present data query method. The components may be defined according to the types of the data sources. In some embodiments, the user-defined components may include a time data component configured to provide implementations for different formats or types of time data in different data sources. For example, the time data component may be configured to convert various time data formats into a uniform format. In one example, different data sources may use different time data formats such as year, month, week, day, hour, minute, or second; and the time data component is configured convert different formats into the uniform format. In another example, the time data component may be configured to convert various time data types (e.g., time stamp data or character string data) into a uniform type.

In some embodiments, the user-defined components may include an aggregation component configured to provide implementations for a same type of aggregation function that are defined differently by different data sources. In one example, different data sources may use different aggregation function names and/or aggregation function parameters for a same aggregation function. The user-defined aggregation component enables implementations for the same type of aggregation function.

In some embodiments, the user-defined components may include a filter component configured to provide implementations for a filter type field. In one example, the user-defined components may include a character filter component, which is configured to process filter type field to generate a filter sub-statement configured to filter character type fields. The implementations provided by the character filter component in some embodiments enables fuzzy matching and/or enumeration during data query. In another example, the user-defined components may include a numeric filter component, which is configured to process filter type field to generate a filter sub-statement configured to filter numeric type fields. In another example, the user-defined components may include a date data filter component, which is configured to process filter type field to generate a filter sub-statement configured to filter date data type fields.

Referring to FIG. 2A, the step of processing the query description in some embodiments includes obtaining query field from the query description; processing the query field using the one or more components; and determining a first sub-statement. In some embodiments, the step of processing the query description includes determining whether the query field comprises an aggregate query field. Upon a determination that the query field comprises an aggregate query field, the method further includes processing the aggregate query field using a first component. The first component is configured to provide implementations for a same type of aggregation function that are defined differently by different data sources. The term “aggregation function” as used herein refers to queries that may contain functions that return aggregate values instead of individual records. Examples of aggregation functions include, but are not limited to, AVG (average), SUM (sum), MAX (maximum value), RMS (root mean square), or the like.

In some embodiments, the step of processing the query description includes determining whether the query field comprises a time data query field; and processing the time data query field using a second component. The second component is configured to provide implementations for different formats or types of time data in different data sources. Upon a determination that the query field comprises a time data query field, the method further includes processing the time data query field using a second component. The second component is configured to provide implementations for different formats or types of time data in different data sources.

Referring to FIG. 2A, the step of processing the query description in some embodiments further includes obtaining filter type field from the query description; processing the filter type field using one or more components; and determining a second sub-statement. Examples of filter type fields include character type fields (filter by characters), numeric type fields (filter by numbers), and date data type fields (filter by dates). As discussed above, the user-defined components may include a character filter component, a numeric filter component, or a date data filter component. Accordingly, in some embodiments, the step of processing the filter type field includes at least one of processing filter type field using a third component to generate a first filter sub-statement configured to filter character type fields; processing filter type field using a fourth component to generate a second filter sub-statement configured to filter numeric type fields; or processing filter type field using a fifth component to generate a third filter sub-statement configured to filter date data type fields. The second sub-statement includes at least one of the first filter sub-statement, the second filter sub-statement, or the third filter sub-statement.

In some embodiments, the data query method further includes obtaining filter condition field from the query description. One example of filter condition is filtering by a single condition. Another example of filter condition is filtering by multiple conditions. Further, the filter condition may be assigned a value such as “containing” or “excluding”. In one example, the filter condition is filtering by containing a single condition. In another example, the filter condition is filtering by excluding a single condition. In one example, the filter condition is filtering by containing multiple conditions. In another example, the filter condition is filtering by excluding multiple conditions. In another example, the filter condition is filtering by containing one or more conditions and excluding one or more conditions.

In some embodiments, the data query method further includes obtaining data source type from the query description.

Referring to FIG. 2A, the step of processing the query description in some embodiments further includes obtaining classification field from the query description; and determining a third sub-statement. In one example, the query results may be classified according to the classification field. As discussed above, in one example, classification fields may include “passenger car” or “carriage truck”. The query results obtained using the query field “vehicle models” may be classified by “passenger car” or “carriage truck”.

Referring to FIG. 2A, the step of processing the query description in some embodiments further includes obtaining order field from the query description; and determining a fourth sub-statement. Examples of order field include an ascending order and a descending order. The query results may be arranged according to the order field.

Referring to FIG. 2A, the data query method in some embodiments further includes joining multiple sub-statements including the first sub-statement into the query statement. In one example, the method includes joining the first sub-statement, the second sub-statement, the third sub-statement, and the fourth sub-statement into the query statement.

In one example, the query field may be “monthly average revenue.” Table 1 illustrates an example of a data source containing information on companies' revenues.

| Company | Revenue (billions) | Month |
|---|---|---|
| A | 100 | January |
| B | 90 | January |
| C | 80 | January |
| D | 70 | January |
| A | 80 | February |
| B | 70 | February |
| C | 60 | February |
| D | 50 | February |

As discussed above, the data query method in some embodiments includes processing the query field using the one or more components; and determining a first sub-statement. An example of a first sub-statement is “select: Company, average monthly revenue in January and February.”

As discussed above, the data query method in some embodiments includes processing the filter type field using one or more components; and determining a second sub-statement. An example of a second sub-statement is “where: Company in (A, B, C, D) and Month in (January and February).”

As discussed above, the data query method in some embodiments includes obtaining classification field from the query description; and determining a third sub-statement. An example of a third sub-statement is “group: Company.”

As discussed above, the data query method in some embodiments includes obtaining order field from the query description; and determining a fourth sub-statement. An example of a fourth sub-statement is “order: average monthly revenue.”

An example of a query statement is “select: Company, average monthly revenue in January and February; where: Company in (A, B, C, D) and Month in (January and February); group: Company; order: average monthly revenue.” The query statement may be generated by joining the first sub-statement, the second sub-statement, the third sub-statement, and the fourth sub-statement.

An example of the query result is shown in Table 2:

| | Monthly average revenue (January and February) |
|---|---|
| Company | (billions) |
| A | 90 |
| B | 80 |
| C | 70 |
| D | 60 |

In one example as described in relation to Table 1, a query field may be “monthly average revenue.” The query field includes both an aggregate query field (average) and a time data query field (monthly). FIG. 2B is a flow chart illustrating a data query method in some embodiments according to the present disclosure. Referring to FIG. 2B, in some embodiments, the step of processing the query description includes determining whether the query field comprises a time data query field; processing the time data query field using a second component upon a determination that the query field comprises a time data query field; determining whether the query field comprises an aggregate query field; and subsequent to processing the time data query field and upon a determination that the query field comprises an aggregate query field, processing the aggregate query field using a first component. The second component is configured to provide implementations for different formats or types of time data in different data sources, and the first component is configured to provide implementations for a same type of aggregation function that are defined differently by different data sources.

As discussed above, in some embodiments, processing the filter type field comprises at least one of processing filter type field using a third component to generate a first filter sub-statement configured to filter character type fields; processing filter type field using a fourth component to generate a second filter sub-statement configured to filter numeric type fields; or processing filter type field using a fifth component to generate a third filter sub-statement configured to filter date data type fields; wherein the second sub-statement comprises at least one of the first filter sub-statement, the second filter sub-statement, or the third filter sub-statement. An example of a second sub-statement is “where: Company in (A, B, C, D) and Month in (January and February), average monthly revenue >60 billions.” An example of the first filter sub-statement is “Company in (A, B, C, D).” An example of the third filter sub-statement is “Month in (January and February).” An example of the second filter sub-statement is “average monthly revenue >60 billions.”

Upon generation of the query statement, the query may be executed. In some embodiments, the data query method further includes loading the query statement onto a query engine; and querying a data source, by the query engine, to obtain query result. Because the present method decouples data description from query statement of the query engine using user-defined components configured to process data descriptions from different data sources into a uniform query statement, various appropriate query engines may be used in the present data query method. Examples of query engines include Presto®, Apache Drill®, Spark®, Impala®, and so on. In one example, the query engine is a distributed query engine such as a distributed SQL query engine. Distributed SQL query engines such as Presto® does not require data storage. For example, Presto® can support many connectors, and query corresponding databases (e.g., mysql, postgresql, mongodb, and elasticsearch) through these connectors. Moreover, Presto® allows a user to develop additional connectors for additional databases. A Presto® query engine includes a coordinator configured to perform query parsing and worker scheduling, and one or more workers configured to perform query execution and computation.

The query statement may be of various appropriate types, depending on the query engine of choice. In one example, the query statement is a SQL statement such as mysql statement, postgresql statement, oracle statement, influxdb statement, iotdb statement, Cassandra statement. In another example, the query statement is a non-SQL statement such as mongodb statement, elasticsearch statement.

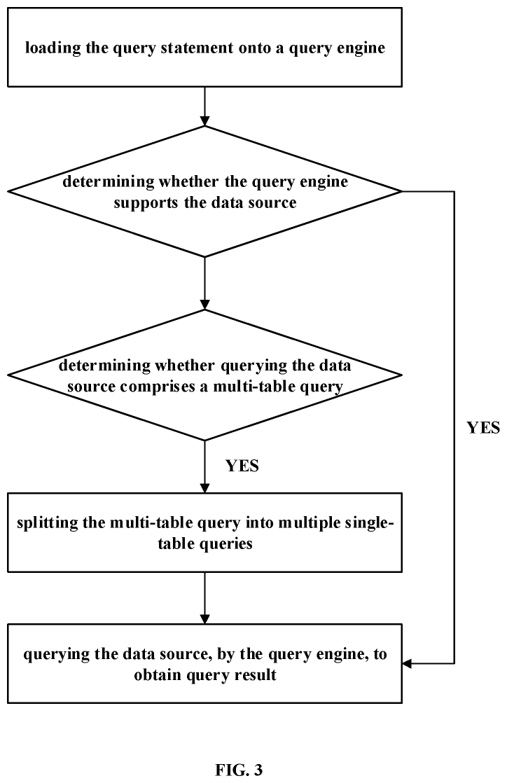

FIG. 3 is a flow chart illustrating a data query method in some embodiments according to the present disclosure. Referring to FIG. 3, the data query method in some embodiments further includes determining whether the query engine supports the data source. Upon a determination that the query engine supports the data source, the method further includes querying the data source, by the query engine, to obtain query result. Upon a determination that the query engine does not support the data source, the method further includes determining whether querying the data source comprises a multi-table query, e.g., the query involves aggregation function in which values of multiple inputs (e.g., respectively from multiple tables) are grouped together to form a single summary value. Upon a determination that querying the data source comprises a multi-table query, the data query method further includes splitting the multi-table query into multiple single-table queries; and assembling query results from the multiple single-table queries, for example, based on the connecting relationship among the multiple tables.

When a multi-table query is involved, the query description contains information on multiple tables. For example, the information may include identifiers of multiple tables that are linked by the multi-table query, a method of joining the multiple tables, and fields to be kept after the joining. In one specific example, the identifiers for the multiple tables may be ID 100 and ID 200, the joining method may be SQL left-outer-join, fields to be kept for Table ID 100 may include “id”, “code”, “name_1”, “name_2”, “name_3”, “name_4”, and fields to be kept for Table ID 200 may include “id”, “code”, “name”, “value”, “update_time”.

The present data query method enables multi-table query, significantly enhancing the flexibility of the data query method. As a result, the present data query method is capable of handling high complicated data query scenarios. In particular, the present data query method can process many-to-many relationship in the query process. The present data query method obviates the needs of creating a single table that is required to contain a large amount of data, greatly reducing data redundancy in the data sources.

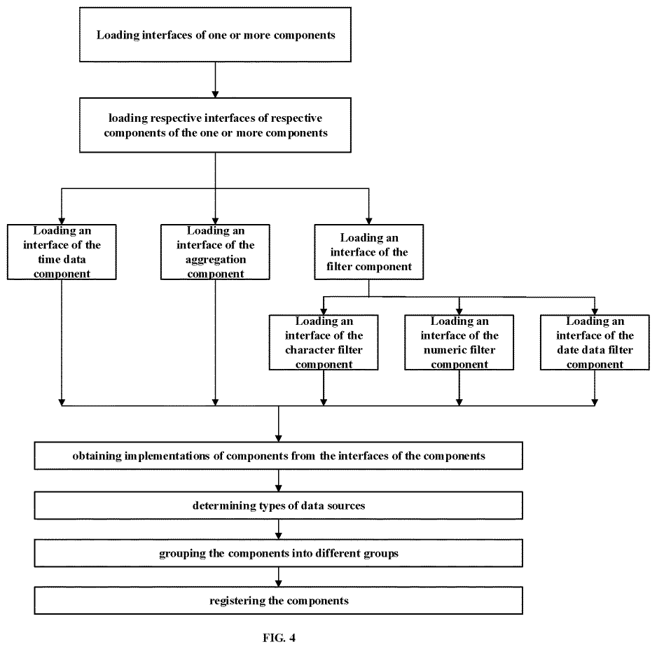

Prior to processing the query description using one or more components, the data query method in some embodiments further includes loading the one or more components. Typically, the loading occurs at the startup of the query. In some embodiments, the data query method further includes loading an interface of a respective component of the one or more components onto a memory; and obtaining respective implementations of the respective component from the interface of the respective component. FIG. 4 is a flow chart illustrating a data query method in some embodiments according to the present disclosure. Referring to FIG. 4, in one example, the data query method includes accessing interfaces of one or more components, thereby accessing respective interfaces of respective components of the one or more components onto a memory. Specifically, the data query method includes at least one of loading an interface of the time data component, loading an interface of the aggregation component, or loading an interface of the filter component. More specifically, loading the interface of the filter component may include at least one of loading an interface of the character filter component, loading an interface of the numeric filter component, or loading an interface of the date data filter component.

In one specific example, the data query method includes loading an interface of a top-level interface of a respective component; obtaining implementations of the top-level interface and any lower-level interfaces associated with the top-level interface from the top-level interface; and classifying the implementations obtained. Numerous advantages over other methods may be achieved by this unique manner of interface loading. For example, this interface loading method eliminates the need for repetitively establishing interface implementations, enabling effective reuse of computational resource, and significantly improving call execution efficiency.

Once the interfaces are loaded onto the memory, the data query method further includes obtaining implementations of components from the interfaces of the components. Optionally, the data query method further includes determining types of data sources; grouping the components into different groups; and registering the components. As used herein, an interface refers to a set of operations (e.g., names of functions) that declares a service convention or protocol provided or requested by a component. As used herein, the term implementation refers to functions that implement the interface of the component. An interface may contain different implementations corresponding to different data sources. To illustrate, in one example, the interface may be “driving a vehicle,” and the interface may include a set of operations such as acceleration, deceleration, changing gears, turning on lights, and so on. In one example, implementations corresponding to “acceleration” operation may include “using a user's right foot to” “step on gas” “steadily”, and so on.

As discussed above, the data query method in some embodiments includes loading an interface of the time data component. In one example, the interface of the time data component may be “Month.” In another example, the implementation of the interface may be “converting time data into yyyy-mm format.” For example, the time data in a data source may have a format of “yyyy-mm-dd hh: mm: ss,” the time data component converts the format into the “yyyy-mm format.”

As discussed above, the data query method in some embodiments includes loading an interface of the aggregation component. In one example, the interface of the aggregation component may be an averaging operation, and the corresponding implementation may be adding an averaging function to a value. For example, the aggregation component is configured to add an averaging function to “revenue,” converting it into a “avg (revenue)” statement.

As discussed above, the data query method in some embodiments includes loading an interface of the character filter component. In one example, the interface of the character filter component may be an operation to filter character and conditions, and assemble the character and condition into a statement. For example, the character filter component is configured to filter character and conditions to obtain “Company” and “(A, B, C, D)”, and assemble them into a statement “Company in (A, B, C, D).”

As discussed above, the data query method in some embodiments includes loading an interface of the numeric filter component. In one example, the interface of the numeric filter component may be an operation to filter numeric data, and assemble the numeric data into a statement. For example, the numeric filter component is configured to filter “avg (revenue)” greater than a threshold value 60 billions, and assemble the numeric data into a statement “avg (revenue)>60 billions.”

As discussed above, the data query method in some embodiments includes loading an interface of the date data filter component. In one example, the interface of the date data filter component may be an operation to filter date data, and assemble the date data into a statement. For example, the date data filter component is configured to filter date data to obtain “Month” and “(January, February)”, and assemble them into a statement “Month in (January, February).”

In some embodiments, the results of processing using the interface of the aggregation component and/or the interface of the aggregation component may be used in the processing using the interfaces of the numeric filter components. For example, “Company” and “avg (revenue)” may be used in the processing using the interfaces of the numeric filter components.

In some embodiments, the data query method further includes determining the query description. Optionally, the step of determining the query description includes defining at least one of the query field, filter type field, filter condition field, and order field.

In some embodiments, the data query method further includes defining the one or more components. A respective component of the one or more components is defined to comprise a plurality of interfaces compatible with different data sources. The respective component is configured to provide implementations for different formats or types of data in the different data sources.

In another aspect, the present disclosure provides a data query apparatus. In some embodiments, the data query apparatus includes a memory; and one or more processors. The memory and the one or more processors are connected with each other. In some embodiments, the memory stores computer-executable instructions for controlling the one or more processors to receive query description; process the query description using one or more components; and determine query statement. Optionally, the one or more processors are configured to obtain query field from the query description; process the query field using the one or more components; and determine a first sub-statement.

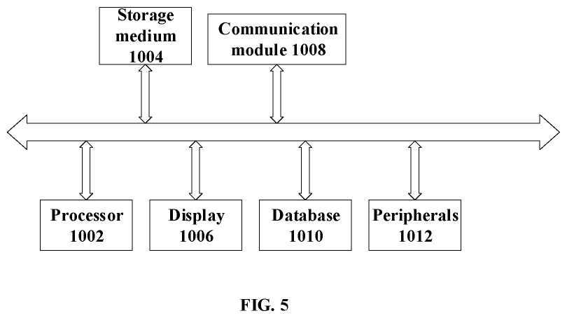

FIG. 5 is a schematic diagram illustrating a data query apparatus in some embodiments according to the present disclosure. Referring to FIG. 5, the data query apparatus may include any appropriate type of TV, such as a plasma TV, a liquid crystal display (LCD) TV, a touch screen TV, a projection TV, a non-smart TV, a smart TV, etc. The data query apparatus may also include other computing systems, such as a personal computer (PC), a tablet or mobile computer, or a smart phone, etc. In addition, the data query apparatus may be any appropriate content-presentation device capable of presenting any appropriate content. Users may interact with the data query apparatus to perform other activities of interest.

As shown in FIG. 5, the data query apparatus may include a processor 1002, a storage medium 1004, a display 1006, a communication module 1008, a database 1010 and peripherals 1012. Certain devices may be omitted, and other devices may be included to better describe the relevant embodiments.

The processor 1002 may include any appropriate processor or processors. Further, the processor 1002 may include multiple cores for multi-thread or parallel processing. The processor 1002 may execute sequences of computer program instructions to perform various processes. The storage medium 1004 may include memory modules, such as ROM, RAM, flash memory modules, and mass storages, such as CD-ROM and hard disk, etc. The storage medium 1004 may store computer programs for implementing various processes when the computer programs are executed by the processor 1002. For example, the storage medium 1004 may store computer programs for implementing various algorithms when the computer programs are executed by the processor 1002.

Further, the communication module 1008 may include certain network interface devices for establishing connections through communication networks, such as TV cable network, wireless network, internet, etc. The database 1010 may include one or more databases for storing certain data and for performing certain operations on the stored data, such as database searching.

The display 1006 may provide information to users. The display 1006 may include any appropriate type of computer display device or electronic apparatus display such as LCD or OLED based devices. The peripherals 112 may include various sensors and other I/O devices, such as keyboard and mouse.

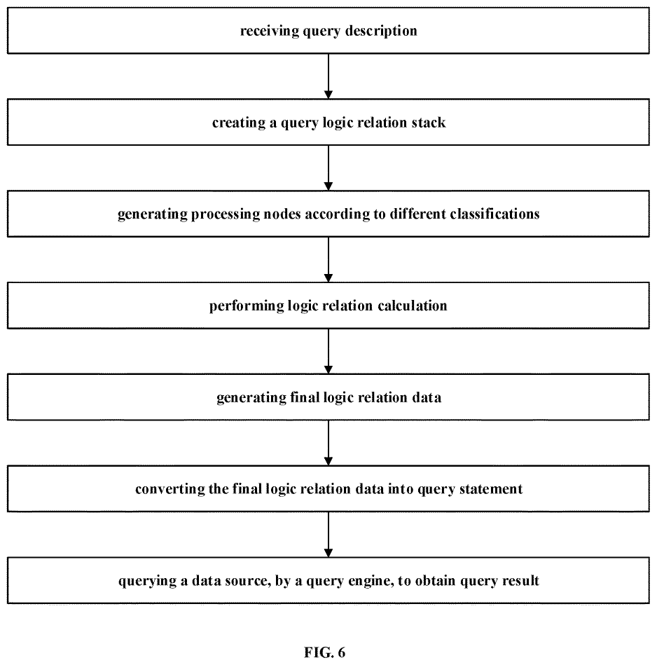

FIG. 6 is a flow chart illustrating a data query method in some embodiments according to the present disclosure. Referring to FIG. 6, the data query method in some embodiments includes receiving query description; creating a query logic relation stack; generating processing nodes according to different classifications; performing logic relation calculation; generating final logic relation data; converting the final logic relation data into query statement; and querying a data source, by a query engine, to obtain query result.

In some embodiments, the query logic relation stack is created based on the query description. In some embodiments, the query logic relation stack is a data structure for storing logic relation data before the query statement is determined. In some embodiments, the query logic relation stack is a first in last out data structure. In some embodiments, the query logic relation stack includes a plurality of processing nodes. In some embodiments, each of the plurality of processing nodes is an operation processing node corresponding to an operation indicated by the query description. In some embodiments, each operation corresponds to a processing logic for processing a query clause. In some embodiments, each of the plurality of processing nodes corresponds to a respective processing type in the query description.

In some embodiments, the different classifications include at least one of a query classification, a field setting classification, a filter classification, an order classification, a grouping classification, an aggregation classification, a formula classification, a vertical table association classification, a horizontal association classification, a conditional column classification, a field adding classification, a field renaming classification, or a field hiding classification. In some embodiments, the different classifications correspond to operation types indicated by the query description. In some embodiments, generating the processing nodes according to the different classifications includes generating at least one of a query processing node, a field setting processing node, a filter processing node, an order processing node, a grouping processing node, an aggregation processing node, a formula processing node, a vertical table association processing node, a horizontal association processing node, a conditional column processing node, a field adding processing node, a field renaming processing node, or a field hiding processing node. In some embodiments, a parser corresponding to a respective classification is selected to parse description information of a respective processing node.

In some embodiments, the different classifications correspond to selectable operations in a user interface, and a user adding one selectable operation corresponds to adding one processing node to the query logic relation stack.

In some embodiments, performing the logic relation calculation includes calculating logic relation among the plurality of processing nodes in the query logic relation stack. In some embodiments, the final logic relation data represents a calculation result of the query logic relation stack. In some embodiments, converting the final logic relation data into the query statement is performed subsequent to performing the logic relation calculation. Thus, in some embodiments, the query statement is generated based on a calculated logic relation rather than by directly joining multiple query sub statements.

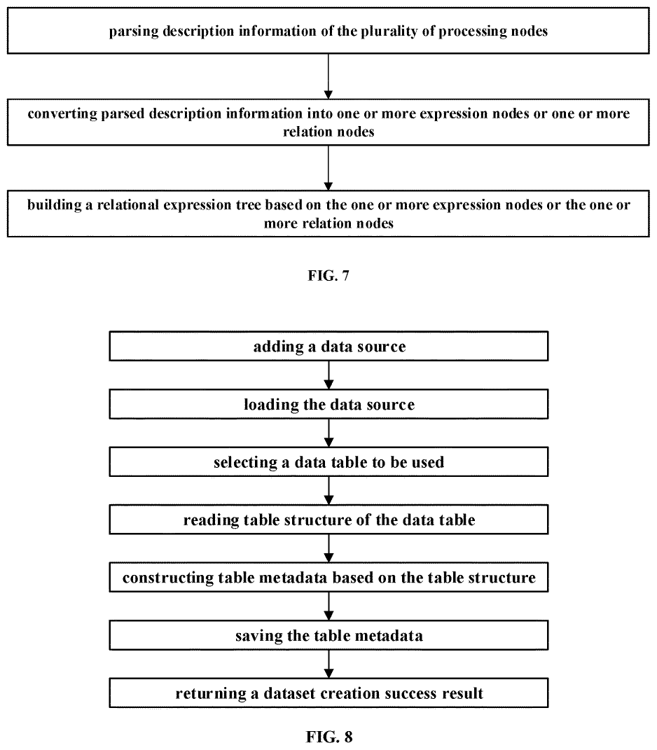

FIG. 7 is a flow chart illustrating a process of performing logic relation calculation in some embodiments according to the present disclosure. Referring to FIG. 7, in some embodiments, performing the logic relation calculation includes parsing description information of the plurality of processing nodes, converting parsed description information into one or more expression nodes or one or more relation nodes, and building a relational expression tree based on the one or more expression nodes or the one or more relation nodes.

In one example, the parsed description information is converted into a RexNode or a RelNode by using an Apache Calcite library. In one example, the relational expression tree is built by using a RelBuilder tool of the Apache Calcite library. In some embodiments, the final logic relation data includes the relational expression tree. In some embodiments, the relational expression tree represents a query plan generated before the query statement is determined.

In some embodiments, the logic relation calculation determines at least one of an execution order, a dependency relation, a nesting relation, or a target data object among the plurality of processing nodes. In some embodiments, the target data object is an original data table. In some embodiments, the target data object is a result generated by a previous processing node. Thus, in some embodiments, a filtering operation or an ordering operation subsequent to a join operation can be applied to a joined result rather than being applied only to one original data table.

As used herein, the term “query logic relation stack” refers to a data structure configured to store a plurality of processing nodes corresponding to processing types in a query description. In some embodiments, the query logic relation stack is a first in last out data structure.

As used herein, the term “operation” refers to processing logic added by a user or indicated by the query description. In some embodiments, one operation corresponds to one processing node. In some embodiments, the operation is configured to process a query clause or query processing logic.

As used herein, the term “processing node” refers to a data element or operation processor in the query logic relation stack. In some embodiments, the processing node corresponds to a respective processing type in the query description. In some embodiments, the processing node stores logic relation information used for determining an execution relationship of the respective processing type.

As used herein, the term “processing type” refers to a type of query processing indicated by the query description. In some embodiments, a classification in FIG. 6 corresponds to a processing type. Examples of processing types include a query type, a field setting type, a filter type, an order type, a grouping type, an aggregation type, a formula type, a vertical table association type, a horizontal association type, a conditional column type, a field adding type, a field renaming type, and a field hiding type.

As used herein, the term “parser” refers to a module, program segment, or processor configured to parse description information of a processing node. In some embodiments, different processing types correspond to different parsers.

As used herein, the term “expression node” refers to a node representing an expression used in query processing. In one example, the expression node is a RexNode. As used herein, the term “relation node” refers to a node representing a relational operation or relational expression used in query processing. In one example, the relation node is a RelNode.

As used herein, the term “relational expression tree” refers to a tree structure including one or more relation nodes or one or more expression nodes. In some embodiments, the relational expression tree represents a query plan generated before the query statement is determined.

As used herein, the term “logic relation” refers to a relationship among processing nodes that indicates an execution order, a dependency relation, a nesting relation, or a target data object for query processing. As used herein, the term “target data object” refers to a data object to which an operation is applied. In some embodiments, the target data object is an original data table. In some embodiments, the target data object is a result generated by a previous processing node.

As used herein, the term “logic relation calculation” refers to calculating a logic relation among a plurality of processing nodes in the query logic relation stack before the query statement is generated. As used herein, the term “final logic relation data” refers to data generated by performing the logic relation calculation on the query logic relation stack. In some embodiments, the final logic relation data includes the relational expression tree and is used for generating the query statement.

Comparing the data query method depicted in FIG. 2A to the data query method depicted in FIG. 6, in the data query method depicted in FIG. 2A, the query description is processed to generate a plurality of query sub statements, and the plurality of query sub statements are joined into the query statement. In contrast, in the data query method depicted in FIG. 6, the query description is not directly converted into query sub statements. Instead, the query description is first converted into a query logic relation stack, logic relation calculation is performed on the query logic relation stack to generate final logic relation data, and the final logic relation data is then converted into the query statement.

The inventors of the present disclosure discover that when query sub statements are directly generated and joined into the query statement, a logic error may occur in a query involving a join operation. For example, after a first table a and a second table b are joined, a subsequent filtering operation or a subsequent ordering operation is expected to be performed based on a result of joining the first table a and the second table b. In one example, the expected logic relation may be represented as “(a join b) as c where c.xxx>100”. In this example, the field xxx may be a field originally included in the second table b, but the filtering operation is expected to be performed on the joined result c rather than being performed only on the second table b.

The inventors of the present disclosure further discover that when a query sub statement is directly generated as a character string, it may be difficult to determine whether a subsequent filtering operation or a subsequent ordering operation should be performed on an original table or on a joined result. As a result, the query statement may be incorrectly generated to represent “a join (b where b.xxx>100)”. In this example, although the field xxx is included in the second table b, the generated query statement does not correctly reflect the intended logic relation because the filtering operation is applied before the join operation rather than being applied to the joined result.

The inventors of the present disclosure further discover that the data query method depicted in FIG. 6 reduces the risk of the logic error described above. Before the query statement is generated, the data query method creates the query logic relation stack and performs logic relation calculation on the query logic relation stack. Thus, the data query method first determines a correct logic relation among a plurality of processing nodes, and then generates the query statement based on the correct logic relation. In this way, the query statement generated from the final logic relation data can accurately reflect an intended relationship among a join operation, a filtering operation, an ordering operation, a grouping operation, or an aggregation operation.

The inventors of the present disclosure further discover that the data query method depicted in FIG. 6 also enables calculation to a selected processing node. In a previous processing manner in which query sub statements are directly generated, each query requires processing all description clauses in the query description to obtain a correct query statement. That is, after multiple processing logics are added, all of the multiple processing logics need to be processed when a query is performed. In contrast, in the data query method depicted in FIG. 6, the logic relation calculation is sequentially performed based on the plurality of processing nodes in the query logic relation stack. Accordingly, regardless of which processing node is selected as an ending node of the logic relation calculation, a correct query statement corresponding to the selected processing node can be obtained. This facilitates management of query configuration.

FIG. 8 is a flow chart illustrating a dataset creation process in some embodiments according to the present disclosure. Referring to FIG. 8, in some embodiments, the dataset creation process includes adding a data source, loading the data source, selecting a data table to be used, reading a table structure of the data table, constructing table metadata based on the table structure, saving the table metadata, and returning a dataset creation success result.

In some embodiments, after the data source is added, the data source is loaded so that one or more data tables in the data source can be accessed. In some embodiments, the data table to be used is selected from the one or more data tables. In some embodiments, reading the table structure of the data table includes obtaining structure information of the selected data table.

In some embodiments, constructing the table metadata based on the table structure includes generating an abstract mapping of the selected data table. In some embodiments, the abstract mapping of the selected data table forms a dataset. In some embodiments, the table metadata includes information describing the selected data table and is associated with the dataset. In some embodiments, saving the table metadata includes saving the table metadata of the dataset. In some embodiments, the dataset is used in a subsequent query configuration process.

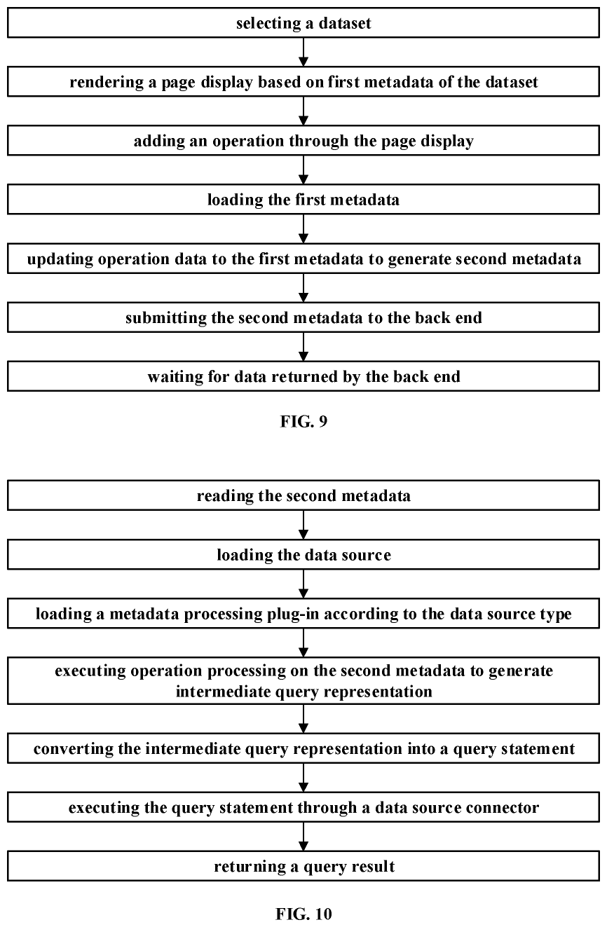

FIG. 9 is a flow chart illustrating a front end query configuration process in some embodiments according to the present disclosure. Referring to FIG. 9, in some embodiments, the front end query configuration process includes selecting a dataset, rendering a page display based on first metadata of the dataset, adding an operation through the page display, loading the first metadata, updating operation data to the first metadata to generate second metadata, submitting the second metadata to the back end, and waiting for data returned by the back end.

In some embodiments, the dataset is selected from one or more datasets created according to the dataset creation process described in connection with FIG. 8. In some embodiments, the first metadata is metadata of the selected dataset before the operation data is added. In some embodiments, the page display is rendered based on the first metadata. In some embodiments, the page display includes one or more fields of the selected dataset and one or more selectable operation controls.

In some embodiments, adding the operation through the page display includes adding a processing logic through the page display. In some embodiments, the operation includes at least one of a field setting operation, a formula operation, a filter operation, an order operation, a vertical table association operation, a horizontal association operation, or a conditional column operation. In some embodiments, the added operation corresponds to a processing node in the query logic relation stack.

In some embodiments, loading the first metadata includes loading metadata corresponding to the selected dataset. In some embodiments, updating the operation data to the first metadata includes adding operation information of the added operation to the first metadata to generate the second metadata. In some embodiments, the operation information includes at least one of an operation identifier, an operation name, a field identifier, a field name, a field type, an operation type, operation parameter configuration, operation status, or operation result message.

In some embodiments, submitting the second metadata to the back end includes transmitting the second metadata to the back end for query construction. In some embodiments, after the second metadata is submitted to the back end, the front end waits for data returned by the back end. In some embodiments, the data returned by the back end includes query result data generated based on the second metadata.

FIG. 10 is a flow chart illustrating a back end query construction and execution process in some embodiments according to the present disclosure. Referring to FIG. 10, in some embodiments, the back end query construction and execution process includes reading the second metadata, loading the data source, loading a metadata processing plug-in according to the data source type, executing operation processing on the second metadata to generate intermediate query representation, converting the intermediate query representation into a query statement, executing the query statement through a data source connector, and returning a query result.

In some embodiments, the second metadata is the second metadata submitted to the back end in the front end query configuration process described in connection with FIG. 9. In some embodiments, the second metadata includes dataset metadata and operation data added through the page display. In some embodiments, the second metadata includes at least one of data source information, table metadata, field information, operation type information, operation parameter information, or operation sequence information.

In some embodiments, loading the data source includes loading a data source corresponding to the dataset indicated by the second metadata. In some embodiments, loading the data source includes obtaining connection information corresponding to the data source. In some embodiments, the data source connector is configured to connect to the data source and execute the query statement.

In some embodiments, loading the metadata processing plug-in according to the data source type includes determining the data source type based on the second metadata and selecting a metadata processing plug-in corresponding to the data source type. In some embodiments, different data source types correspond to different metadata processing plug-ins. In some embodiments, the metadata processing plug-in is configured to parse operation data in the second metadata and execute operation processing based on the parsed operation data.

In some embodiments, executing operation processing on the second metadata to generate the intermediate query representation includes processing a plurality of operations in the second metadata according to an operation sequence. In some embodiments, the plurality of operations include at least one of a field setting operation, a formula operation, a filter operation, an order operation, a vertical table association operation, a horizontal association operation, or a conditional column operation. In some embodiments, the intermediate query representation is generated based on processing results of the plurality of operations.

In some embodiments, the intermediate query representation represents a query logic before the query statement is generated. In one example, the intermediate query representation includes a RelNode. In one example, the intermediate query representation is generated by using an Apache Calcite library. In some embodiments, converting the intermediate query representation into the query statement includes converting the query logic represented by the intermediate query representation into a query language executable by the data source connector. In some embodiments, converting the intermediate query representation into the query statement includes converting the query logic represented by the intermediate query representation into a SQL dialect executable by a data source connector corresponding to a data source type.

In some embodiments, the query statement is executed through the data source connector to query the data source. In one example, the data source connector includes a JDBC driver. In some embodiments, after the query statement is executed, a query result is obtained from the data source and returned to the front end.

In some embodiments, the query statement is not executed based on a unified Presto query engine. In some embodiments, the query statement is executed based on a data source connector corresponding to a respective data source. In one example, the data source connector includes a JDBC driver corresponding to the respective data source. In some embodiments, different data sources correspond to different JDBC drivers, and the query statement is executed through a JDBC driver corresponding to a target data source.

In some embodiments, Presto is configured as one type of data source in a data source layer. In some embodiments, Presto is arranged at a same data source layer as a PostgreSQL data source, a MySQL data source, or another database data source. In some embodiments, the back end query construction and execution process loads a data source connector according to a data source type of the target data source, and executes the query statement through the loaded data source connector.

In some embodiments, the logic relation calculation and conversion from logic relation data to the query statement are performed through an Apache Calcite library. In some embodiments, the Apache Calcite library converts the final logic relation data into a SQL dialect corresponding to the data source type. In one example, when the data source type is PostgreSQL, the Apache Calcite library converts the final logic relation data into a PostgreSQL SQL dialect. In another example, when the data source type is MySQL, the Apache Calcite library converts the final logic relation data into a MySQL SQL dialect. In another example, when the data source type is Presto, the Apache Calcite library converts the final logic relation data into a Presto SQL dialect.

The inventors of the present disclosure further discover that, when query sub statements are directly generated based on Presto syntax, each query sub statement needs to satisfy syntax rules of Presto, thereby limiting modification and extension of query processing logic. In contrast, in the data query method according to some embodiments of the present disclosure, the query statement is not directly generated during generation of the plurality of processing nodes. Instead, the plurality of processing nodes in the query logic relation stack are generated based on a unified and controllable custom specification. The logic relation calculation is performed based on the Apache Calcite library, and the calculated logic relation is converted into a SQL dialect corresponding to the data source type. Accordingly, the data query method is more convenient to modify and extend, and query construction can be more easily standardized at an implementation layer.

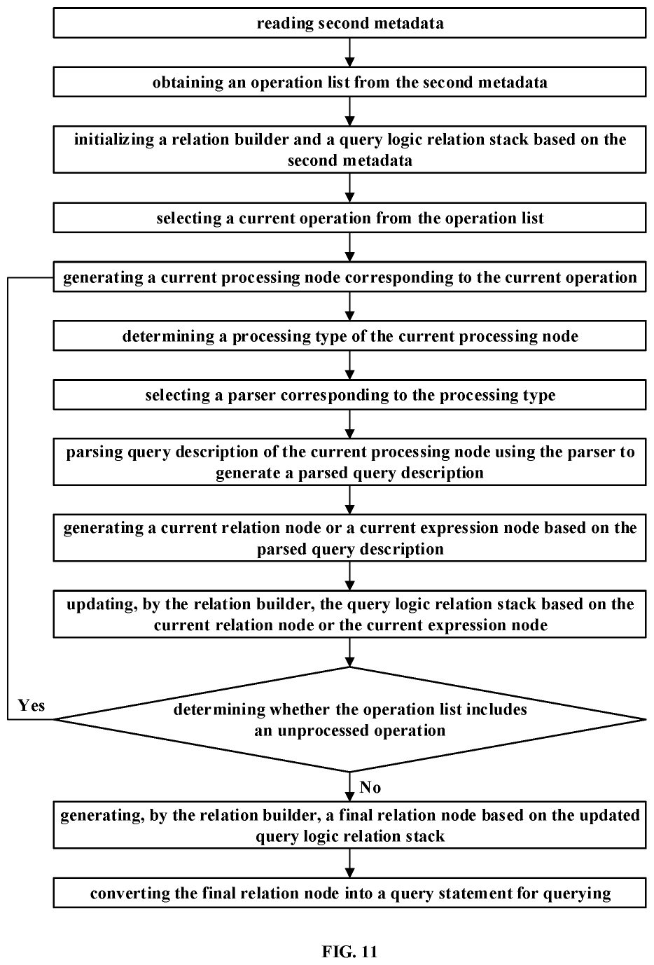

FIG. 11 is a flow chart illustrating an operation processing process in some embodiments according to the present disclosure. Referring to FIG. 11, in some embodiments, the operation processing process includes reading second metadata, obtaining an operation list from the second metadata, initializing a relation builder and a query logic relation stack based on the second metadata, selecting a current operation from the operation list, generating a current processing node corresponding to the current operation, determining a processing type of the current processing node, selecting a parser corresponding to the processing type, parsing query description of the current processing node using the parser to generate a parsed query description, generating a current relation node or a current expression node based on the parsed query description, updating, by the relation builder, the query logic relation stack based on the current relation node or the current expression node, and determining whether the operation list includes an unprocessed operation. Upon determination that the operation list does not include an unprocessed operation, the operation processing process further includes generating, by the relation builder, a final relation node based on the updated query logic relation stack, and converting the final relation node into a query statement for querying. Upon determination that the operation list includes an unprocessed operation, the operation processing process returns to selecting an operation from the operation list.

In some embodiments, the second metadata includes the operation list. In some embodiments, the operation list includes a plurality of operations arranged according to an operation sequence. In some embodiments, each of the plurality of operations corresponds to a processing logic added through a page display. In some embodiments, each of the plurality of operations corresponds to one processing node in the query logic relation stack.

In some embodiments, initializing the relation builder and the query logic relation stack based on the second metadata includes initializing the relation builder according to dataset information, data source information, table metadata, and field information in the second metadata. In some embodiments, the relation builder is configured to update the query logic relation stack during processing of the plurality of operations.

In some embodiments, selecting the current operation from the operation list includes selecting one operation from the operation list according to the operation sequence. In some embodiments, generating the current processing node corresponding to the current operation includes generating an operation processing node corresponding to processing logic of the current operation.

In some embodiments, determining the processing type of the current processing node includes determining whether the current processing node corresponds to at least one of a field setting operation, a formula operation, a filter operation, an order operation, a vertical table association operation, a horizontal association operation, a conditional column operation, a grouping operation, or an aggregation operation.

In some embodiments, selecting the parser corresponding to the processing type includes selecting one parser from a plurality of parsers according to the processing type of the current processing node. In some embodiments, different processing types correspond to different parsers. In some embodiments, the parser is configured to parse the query description of the current processing node to generate the parsed query description.

In some embodiments, generating the current relation node or the current expression node based on the parsed query description includes converting the parsed query description into an intermediate node for representing query processing logic of the current operation. In some embodiments, the current relation node represents relational processing logic of the current operation. In some embodiments, the current expression node represents expression processing logic of the current operation.

In some embodiments, updating, by the relation builder, the query logic relation stack based on the current relation node or the current expression node includes adding the current relation node or the current expression node to the query logic relation stack, or modifying a node stored in the query logic relation stack based on the current relation node or the current expression node. In some embodiments, when the operation list includes an unprocessed operation, another operation is selected from the operation list as the current operation.

In some embodiments, when the operation list does not include an unprocessed operation, the relation builder generates the final relation node based on the updated query logic relation stack. In some embodiments, the final relation node represents a query plan corresponding to the plurality of operations in the operation list. In some embodiments, converting the final relation node into the query statement for querying includes converting the query plan represented by the final relation node into a query statement executable by a data source connector.

In some embodiments, the operation processing process further includes determining whether an error exists during processing of the current processing node. In some embodiments, the error includes at least one of a parsing error, a field mismatch error, a data type mismatch error, a missing operation parameter error, a relation node generation error, an expression node generation error, or a query logic relation stack update error. In some embodiments, upon a determination that the error exists, the operation processing process records error information corresponding to the current processing node. In some embodiments, the error information includes at least one of an identifier of the current operation, an identifier of the current processing node, an error type, an error message, or a processing status. In some embodiments, the error information is returned for display on the page display, so that the query configuration can be adjusted based on the error information.

In some embodiments, the relation builder is implemented by a RelBuilder tool of an Apache Calcite library. In some embodiments, the relation node is implemented by a RelNode of the Apache Calcite library, and the expression node is implemented by a RexNode of the Apache Calcite library. In some embodiments, the RelNode represents relational processing logic, such as table scanning, filtering, projection, joining, grouping, aggregation, or sorting. In some embodiments, the RexNode represents expression processing logic, such as a filtering condition, a formula expression, a field conversion expression, or a conditional column expression. In some embodiments, the RelBuilder tool includes a stack structure configured to store one or more frames. In some embodiments, each frame includes a RelNode and field mapping information. In some embodiments, when a respective operation is processed, the RelBuilder tool obtains an input frame from the stack structure, generates a new RelNode based on the current relation node or the current expression node, and pushes a new frame including the new RelNode back into the stack structure. In some embodiments, after the plurality of operations are processed, the RelBuilder tool outputs the final relation node as the query plan corresponding to the operation list.

In some embodiments, selecting the parser corresponding to the processing type includes selecting the parser from a plurality of parsers according to the processing type of the current processing node. In some embodiments, the plurality of parsers include at least one of a field filtering parser, a formula column adding parser, a field setting parser, a field sorting parser, a grouping and aggregation parser, a table association parser, or a conditional column adding parser. In some embodiments, the field setting parser is configured to parse description information related to at least one of field formatting, field type conversion, field display, or field hiding. In some embodiments, the selected parser parses the query description of the current processing node to generate the parsed query description corresponding to the current processing node.

In some embodiments, updating the query logic relation stack by the relation builder includes performing an optimization calculation on one or more relation nodes or one or more expression nodes in the query logic relation stack. In one example, the optimization calculation includes at least one of predicate pushdown, projection pruning, join order adjustment, or expression simplification. In some embodiments, after the plurality of operations are processed, a plurality of logic processing nodes in the query logic relation stack are merged into the final relation node. In one example, the final relation node is a RelNode representing the query plan corresponding to the plurality of operations.

All or some of steps of the method, functional modules/units in the system and the device disclosed above may be implemented as software, firmware, hardware, or suitable combinations thereof. In a hardware implementation, a division among functional modules/units mentioned in the above description does not necessarily correspond to the division among physical components. For example, one physical component may have a plurality of functions, or one function or step may be performed by several physical components in cooperation. Some or all of the physical components may be implemented as software executed by a processor, such as a central processing unit, a digital signal processor, or a microprocessor, or as hardware, or as an integrated circuit, such as an application specific integrated circuit. Such software may be distributed on a computer-readable storage medium, which may include a computer storage medium (or a non-transitory medium) and a communication medium (or a transitory medium). The term computer storage medium includes volatile and nonvolatile, removable and non-removable media implemented in any method or technology for storage of information, such as computer readable instructions, data structures, program modules or other data, as is well known to one of ordinary skill in the art. A computer storage medium includes, but is not limited to, RAM, ROM, EEPROM, flash memory or other memory technology, CD-ROM, Digital Versatile Disk (DVD) or other optical disk storage, magnetic cassette, magnetic tape, magnetic disk storage or other magnetic storage device, or any other medium which may be used to store desired information, and which may be accessed by a computer. In addition, a communication medium typically embodies computer readable instructions, data structures, program modules or other data in a modulated data signal such as a carrier wave or other transport mechanism, and includes any information delivery medium, as is well known to one of ordinary skill in the art.

The flowchart and block diagrams in the drawings illustrate architecture, functionality, and operation of possible implementations of a device, a method and a computer program product according to various embodiments of the present disclosure. In this regard, each block in the flowchart or block diagrams may represent a module, program segment(s), or a portion of a code, which includes at least one executable instruction for implementing specified logical function(s). It should also be noted that, in some alternative implementations, functions noted in the blocks may occur out of the order noted in the drawings. For example, two blocks being successively connected may, in fact, be performed substantially concurrently, or the blocks may sometimes be performed in the reverse order, depending upon the functionality involved. It will also be noted that each block of the block diagrams and/or flowchart, and combinations of blocks in the block diagrams and/or flowchart, may be implemented by special purpose hardware-based systems that perform the specified functions or operations, or combinations of special purpose hardware and computer instructions.

In another aspect, the present disclosure provides a computer-program product comprising a non-transitory tangible computer-readable medium having computer-readable instructions thereon. In some embodiments, the computer-readable instructions being executable by a processor to cause the processor to perform receiving query description; processing the query description using one or more components; and determining query statement. Optionally, processing the query description includes obtaining query field from the query description; processing the query field using the one or more components; and determining a first sub-statement.

The foregoing description of the embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A data query method, comprising:
receiving query description;
processing, by a processor, the query description using one or more components;
determining query statement; and
querying a data source based on the query statement to obtain query result;
wherein processing the query description using the one or more components comprises:
creating a query logic relation stack based on the query description;
generating a plurality of processing nodes in the query logic relation stack according to a plurality of processing types indicated by the query description; and
performing logic relation calculation on the query logic relation stack to generate final logic relation data;
wherein determining the query statement comprises converting the final logic relation data into the query statement.

2. The data query method of claim 1, wherein the query description indicates a plurality of operations;
each of the plurality of operations corresponds to a respective processing type of the plurality of processing types; and
each of the plurality of processing nodes corresponds to a respective operation of the plurality of operations.

3. The data query method of claim 2, wherein the respective operation corresponds to processing logic configured to process a query clause of the query description or query processing information indicated by the query description.

4. The data query method of claim 1, wherein the plurality of processing types include at least one of a query type, a field setting type, a filter type, an order type, a grouping type, an aggregation type, a formula type, a vertical table association type, a horizontal association type, a conditional column type, a field adding type, a field renaming type, or a field hiding type.

5. The data query method of claim 1, further comprising:
selecting a dataset;
rendering a page display based on first metadata of the dataset;
adding an operation through the page display;
updating operation data of the operation to the first metadata to generate second metadata; and
submitting the second metadata to a back end for query construction;
wherein at least part of the query description is generated based on the second metadata.

6. The data query method of claim 5, prior to selecting the dataset, further comprising:
adding the data source;
loading the data source;
selecting a data table to be used from the data source;
reading a table structure of the data table;
constructing table metadata based on the table structure; and
saving the table metadata;
wherein the table metadata includes information describing the data table and is associated with the dataset.

7. The data query method of claim 5, wherein the second metadata includes an operation list including a plurality of operations arranged according to an operation sequence.

8. The data query method of claim 7, wherein generating the plurality of processing nodes comprises:
selecting a current operation from the operation list according to the operation sequence; and
generating a current processing node in the query logic relation stack corresponding to the current operation.

9. The data query method of claim 8, further comprising:
determining a processing type of the current processing node;
selecting a parser corresponding to the processing type; and
parsing, using the parser, a portion of the query description corresponding to the current processing node to generate a parsed query description.

10. The data query method of claim 9, wherein the parser is selected from a plurality of parsers, and wherein the plurality of parsers include at least one of a field filtering parser, a formula column adding parser, a field setting parser, a field sorting parser, a grouping and aggregation parser, a vertical table association parser, a horizontal table association parser, or a conditional column adding parser.

11. The data query method of claim 9, further comprising generating, for the current processing node, a current relation node or a current expression node based on the parsed query description.

12. The data query method of claim 11, wherein performing the logic relation calculation comprises updating, by a relation builder, the query logic relation stack based on the current relation node or the current expression node.

13. The data query method of claim 12, wherein, upon a determination that the operation list includes an unprocessed operation, the data query method returns to selecting another operation from the operation list as the current operation.

14. The data query method of claim 12, wherein, upon a determination that the operation list does not include an unprocessed operation, the relation builder generates a final relation node based on the query logic relation stack after the query logic relation stack is updated by the relation builder, and the final logic relation data includes the final relation node.

15. The data query method of claim 14, wherein the final relation node represents a query plan corresponding to the plurality of operations in the operation list.

16. The data query method of claim 12, wherein the relation builder is implemented by a RelBuilder tool of an Apache Calcite library, the current relation node or the final relation node is implemented by a RelNode of the Apache Calcite library, and the current expression node is implemented by a RexNode of the Apache Calcite library.

17. The data query method of claim 5, further comprising:
reading, by the back end, the second metadata;
loading the data source corresponding to the dataset indicated by the second metadata;
determining a data source type based on the second metadata;
selecting a metadata processing component corresponding to the data source type; and
executing, by the metadata processing component, operation processing on the second metadata to generate an intermediate query representation;
wherein the final logic relation data includes the intermediate query representation;
wherein the method further comprises:
converting the intermediate query representation into the query statement; and
executing the query statement through a data source connector to obtain the query result.

18. The data query method of claim 1, wherein the logic relation calculation determines at least one of an execution order, a dependency relation, a nesting relation, or a target data object for at least one of the plurality of processing nodes; and
wherein, when the plurality of processing nodes include a join processing node and a filter processing node or an order processing node subsequent to the join processing node, a target data object of the filter processing node or the order processing node is determined as a joined result generated by the join processing node rather than an original data table.

19. A data query apparatus, comprising:
a memory;
one or more processors;
wherein the memory and the one or more processors are connected with each other; and
the memory stores computer-executable instructions for controlling the one or more processors to:
receive query description;
process the query description using one or more components;
determine query statement; and
query a data source based on the query statement to obtain query result;
wherein the one or more processors are configured to:
create a query logic relation stack based on the query description;
generate a plurality of processing nodes in the query logic relation stack according to a plurality of processing types indicated by the query description;
perform logic relation calculation on the query logic relation stack to generate final logic relation data; and
convert the final logic relation data into the query statement.

20. A computer-program product comprising a non-transitory tangible computer-readable medium having computer-readable instructions thereon, the computer-readable instructions being executable by a processor to cause the processor to perform:
receiving query description;
processing the query description using one or more components;
determining query statement; and
querying a data source based on the query statement to obtain query result;
wherein processing the query description using the one or more components comprises:
creating a query logic relation stack based on the query description;
generating a plurality of processing nodes in the query logic relation stack according to a plurality of processing types indicated by the query description; and
performing logic relation calculation on the query logic relation stack to generate final logic relation data;
wherein determining the query statement comprises converting the final logic relation data into the query statement.
